(19) United States
(12) Patent Application Publication
(10) Pub. No.: US 2009/0060454 A1
(43) Pub. Date: Mar. 5, 2009

(54) PLAYBACK APPARATUS, PLAYBACK METHOD, AND FORMAT

(75) Inventor: Kazuyoshi Shimomura, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/130,967

(22) Filed: May 30, 2008

(30) Foreign Application Priority Data
Aug. 30, 2007 (JP) 2007-224365

(51) Int. Cl. H04N 7/00

(52) U.S. Cl. 386/95

(57) ABSTRACT

According to one embodiment, a playback apparatus, includes: a decoder that decodes stream data to output a video signal, a generator that generates a transparency update signal and a layout update signal based on transparency information and layout information that are described in a script file such that the transparency update signal and the layout update signal are generated to synchronize with each other; and an output unit that outputs the video signal with a transparency updated according to the transparency update signal and with a layout coordinate synchronously updated according to the layout update signal.

### CROSS-REFERENCE TO RELATED APPLICATIONS

This application is based upon and claims the benefit of priority from JP-A-2007-224365, filed Aug. 30, 2007, the entire contents of which are incorporated herein by reference.

### BACKGROUND

1. Field

One embodiment of the invention relates to a playback apparatus which synchronously executes processings respectively to update transparency and lay-out respectively contained in a stream, a playback method for carrying out such synchronous update processings, and a format.

2. Description of the Related Art

As known well, according to the HD DVD-Video standard, differently from the conventional DVD-Video standard, besides a main video, a privileged video such as a commentary video can be displayed as a sub video synchronously with the main video. Referring to the display position of the sub video, when a contents producer describes a change layout function defined according to the HD DVD-Video in a script, the sub video display position can be defined at an arbitrary position. Also, when the contents producer describes the transparency of a sub video plane in the script, the sub video plane transparency can be set at arbitrary transparency. In the advanced contents that are now on sale, the contents producer carries out the animation of the sub video plane using the change layout function and the setting of the transparency.

In the patent reference JP-A-2007-048348, there is disclosed an information playback apparatus which, including a playback portion for playback advanced contents, not only can display a sub video on a main video but also can set the position, size and transparency of the sub video, whereby scaling and alpha processings are carried out as a series of processings.

However, according to the conventional technology disclosed in the patent reference 1, since the setting of the change layout and the setting of the transparency are respectively set at asynchronous timings, there is a possibility that the change layout and transparency cannot be updated in such a manner as the contents producer intends. Also, since a mechanism for synchronizing the change layout and transparency setting timings is not established, depending on playback players, in some cases, there is a possibility that playback operations can vary.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of an example of the structure of a playback apparatus according to an embodiment of the invention.

FIG. 2 is an explanatory view of an example of an unexpected display screen with the transparency and layout update processings not synchronized, that is, the display screen that the playback apparatus is going to avoid.

FIG. 3 is an explanatory view of an example of an expected display screen in which the transparency and layout update are synchronized owing to the operation of the playback apparatus.

FIG. 4 is an explanatory view of an example of an unexpected display screen with the transparency and layout update processings not synchronized, that is, the display screen that the playback apparatus is going to avoid.

FIG. 5 is an explanatory view of an example of an expected display screen in which the transparency and layout update are synchronized owing to the operation of the playback apparatus.

FIG. 6 is an exemplary flow chart of an example of transparency and layout update processings synchronized owning to the synchronization information of the playback apparatus.

FIG. 7 is an exemplary flow chart of an example of transparency and layout update processings to be executed by the playback apparatus with synchronous information and asynchronous information intermingled.

FIG. 8 is an exemplary timing chart of an example of transparency and layout update processings to be executed by the playback apparatus in such a manner that they are synchronized owning to the setting period of the playback apparatus.

FIG. 9 is an exemplary timing chart of an example of transparency and layout update processings to be executed by the playback apparatus in such a manner that they are synchronized owning to the synchronization information of the playback apparatus.

FIG. 10 is an exemplary flow chart of an example of transparency and layout update processings to be executed by the playback apparatus after the video playback is initiated.

FIG. 11 is an exemplary flow chart of an example of transparency and layout update processings to be executed by the playback apparatus after the video playback is initiated.

FIG. 12 is an exemplary flow chart of an example of transparency and layout update processings to be executed by the playback apparatus in such a manner that they are synchronized owning to the setting period of the playback apparatus.

FIG. 13 is an exemplary timing chart of an example of transparency and layout update processings to be executed by the playback apparatus in such a manner that they are synchronized owning to two or more kinds of synchronization information of the playback apparatus.

FIG. 14 is an explanatory view of an example of an optical disk including transparency setting information and layout setting information provided with synchronization information.

### DETAILED DESCRIPTION

Various embodiments according to the invention will be described hereinafter with reference to the accompanying drawings. In general, according to one embodiment of the invention, a playback apparatus includes: a decoder that decodes stream data to output a video signal, a generator that generates a transparency update signal and a layout update signal based on transparency information and layout information that are described in a script file such that the transparency update signal and the layout update signal are generated to synchronize with each other; and an output unit that outputs the video signal with a transparency updated according to the transparency update signal and with a layout coordinate synchronously updated according to the layout update signal.

Now, description will be given below in detail of an embodiment according to the invention with reference to the accompanying drawings.

<Example of Structure of Playback Apparatus According to Embodiment of the Invention>

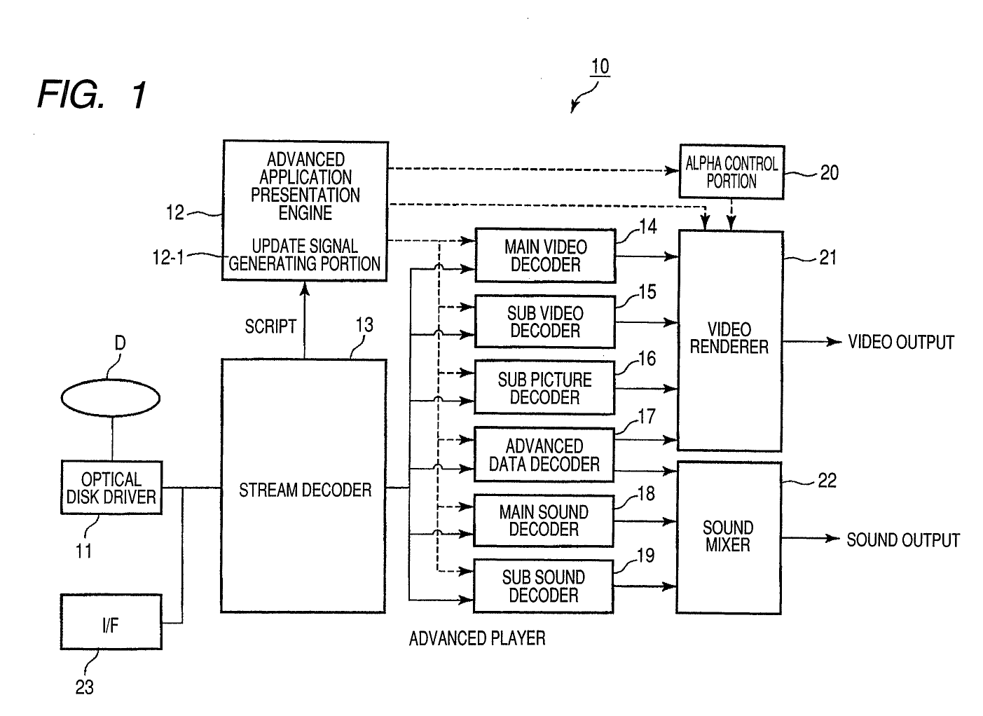

Now, description will be given below in detail of an example of the structure of a playback apparatus according to an embodiment of the invention with reference to the accompanying drawings. FIG. 1 is a block diagram of an example of the structure of a playback apparatus according to an embodiment of the invention.

A playback apparatus 10 according to an embodiment of the invention includes an optical disk driver 11, an I/F portion 23 for obtaining a stream from outside, an advanced application presentation engine 12 and an update signal generating portion 12-1, a stream decoder 13, a main video decoder 14, a sub video decoder 15, a sub vide decoder 16, and advanced data decoder 17, a main sound decoder 18, a sub sound decoder 19, an alpha control portion 20, a video renderer 21, and a sound mixer 22.

The advanced application presentation engine 12 interprets a script contained in advanced contents transmitted from the stream decoder 13. And, the advanced application presentation engine 12 notifies the alpha control portion 20 of the setting of transparency, notifies the video renderer 21 of the setting of layout information to be given by a change layout function, and notifies the main video decoder 14, sub video decoder 15, sub video decoder 16 and advanced data decoder 17 of a playback mode (such as a normal playback mode and a stop mode).

The alpha control portion 20 holds the transparency of a plane to be set by the advanced application presentation engine 12, and sets the plane transparency in the video renderer 21.

The stream decoder 13 divides the stream data into six divisional data, namely, main video pack data composed of main video data, sub video pack data composed of sub video data, sub video pack data composed of sub video pack data, advanced pack data composed of advanced data, audio pack data composed of main audio data, and sub video pack data composed of sub audio data; and, the stream decoder 13 transfers the respective divisional data to their associated decoder, namely, the main video decoder 14, sub video decoder 15, sub video decoder 16, advanced data decoder 17, main video decoder 14 and sub video decoder 15.

Also, script description, which has been created and contained in a data source (such as an optical disk) by a contents producer, is transmitted to and interpreted by the advanced application presentation engine 12.

The main vide decoder 14 decodes main video data transferred thereto from the stream decoder 13 and then transfers the decoded data to the video renderer 21.

The sub video decoder 15 decodes sub video data transferred thereto from the stream decoder 13 and then transfers the decoded data to the video renderer 21.

The sub video decoder 16 decodes sub video data transferred thereto from the stream decoder 13 and then transfers the decoded data to the video renderer 21.

The advanced data decoder 17 decodes advanced data transferred thereto from the stream decoder 13. And, when the advanced data is graphic data, the advanced data decoder 17 transfers the decoded data to the video renderer 21 and, when the advanced data is sound data, it transfers the decoded data to the sound mixer 22.

The main sound decoder 18 decodes main audio data transferred thereto from the stream decoder 13 and then transfers the decoded data to the sound mixer 22.

The sub sound decoder 19 decodes sub audio data transferred thereto from the stream decoder 13 and then transfers the decoded data to the sound mixer 22.

The video renderer 21 multiplexes data respectively output from the main video decoder 14, sub video decoder 15, sub video decoder 16 and advanced data decoder 17.

The video renderer 21 allocates the data output from the decoders to the respective planes, and also manages the data. The video renderer 21 also handles layout information on main and sub video planes given by the change layout function from the advanced application presentation engine 12.

The sound mixer 22 multiplexes data output from the advanced data decoder 17, main video decoder 14 and sub video decoder 15.

<Transparency and Layout Update Processings by Playback Apparatus>

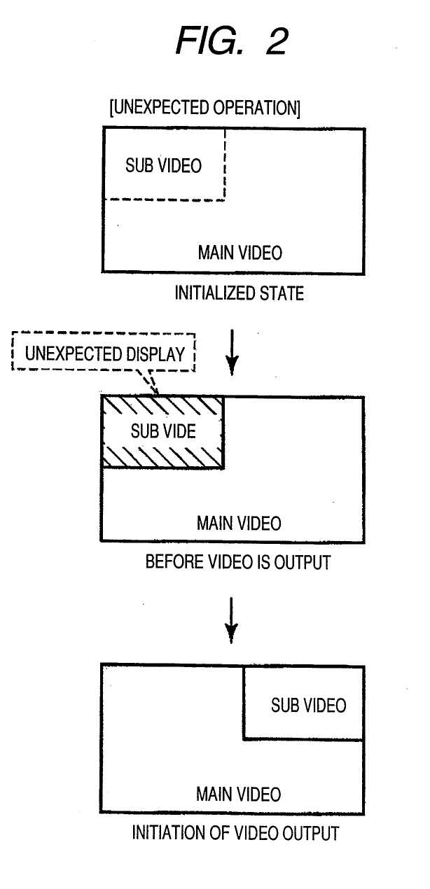

Next, the above-structured playback apparatus 10 carries out the following transparency and layout update processings. Specifically, FIG. 2 is an explanatory view of an example of a display screen in which the transparency and layout data processings are not synchronized, that is, the display screen that the playback apparatus is to avoid. It is assumed that, when initiating the output of the videos, the contents producer has already described a script in such a manner as to be able to initiate the playback of the sub video in a non-transparent state at an upper left position on the display screen.

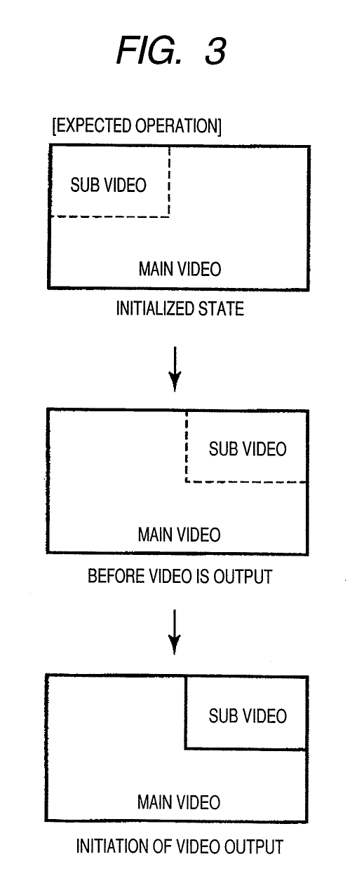

In FIG. 2, in the playback apparatus 10, the transparency processing is executed prior to the output of the videos and the layout is changed after the output of the videos, resulting in the unexpected display on the display screen. FIG. 3 is an explanatory view of an example of an expected display on the display screen that is obtained in a synchronized state owing to the operation of the playback apparatus 10. In this case, since the transparency update processing and layout change processing are carried out synchronously according to a method which will be discussed later, there can be executed an expected operation.

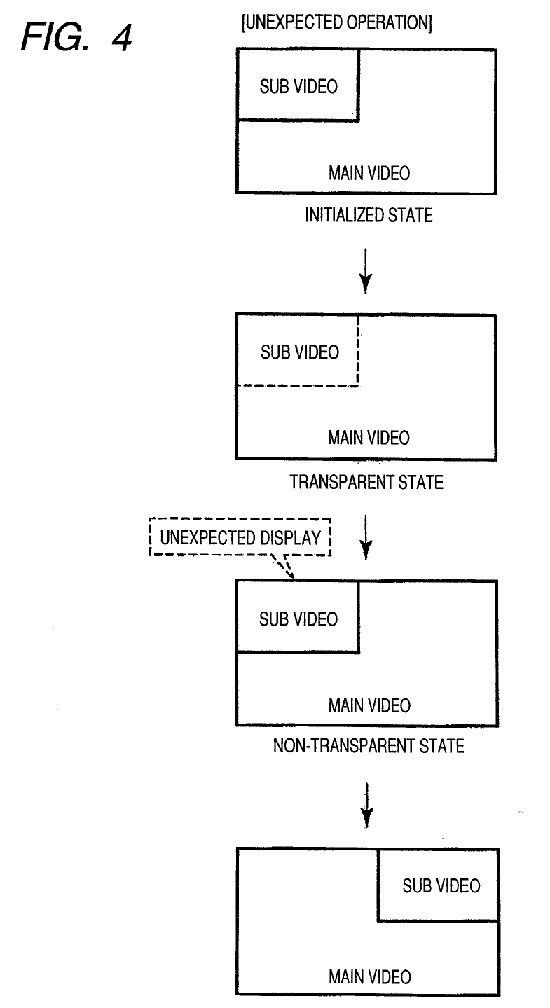

Similarly, FIG. 4 is an explanatory view of an example of a display screen in which the transparency and layout data processings are not synchronized, that is, the display screen that the playback apparatus 10 is to avoid.

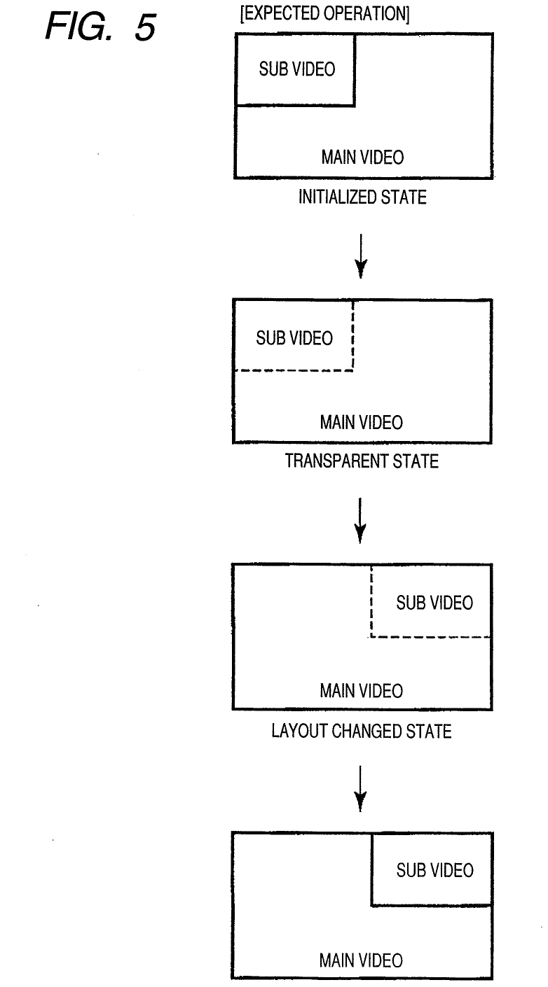

After the state of the sub video was changed to a transparent state from a state (an initial state) where the sub video had been displayed in a nontransparent manner at an upper right position on the display screen, suppose that the contents producer has described a script in such a manner as to be able to initiate the playback of the sub video in a nontransparent manner at an upper left position on the display screen. In FIG. 4, in the playback apparatus 10, the nontransparent processing is carried out before the layout is changed, resulting in the unexpected display. FIG. 5 is an explanatory view of an example of an expected display screen obtained when the transparency and layout change update processings are synchronized owing to the operation of the playback apparatus 10. Since the transparency update processing and layout change processing are carried out synchronously according to a method which will be discussed later, there can be executed an expected operation.

By the way, in FIGS. 2 to 5, the broken-line portion of the sub video plane shows that the sub video is not displayed on the screen.

<Synchronous Transparency and Layout Update Processings to be Executed by Playback Apparatus According to Embodiment of the Invention>

Next, description will be given below of synchronous transparency and layout update processings to be executed by a playback apparatus according to an embodiment of the invention with reference to the accompanying drawings.

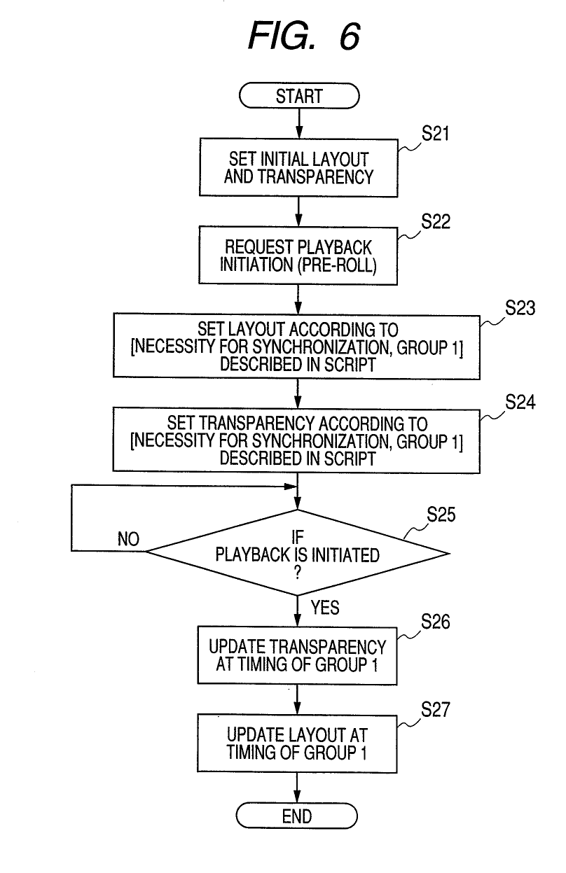

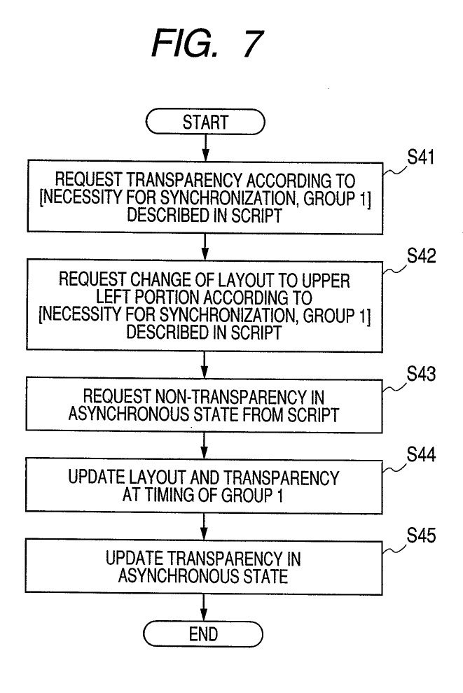

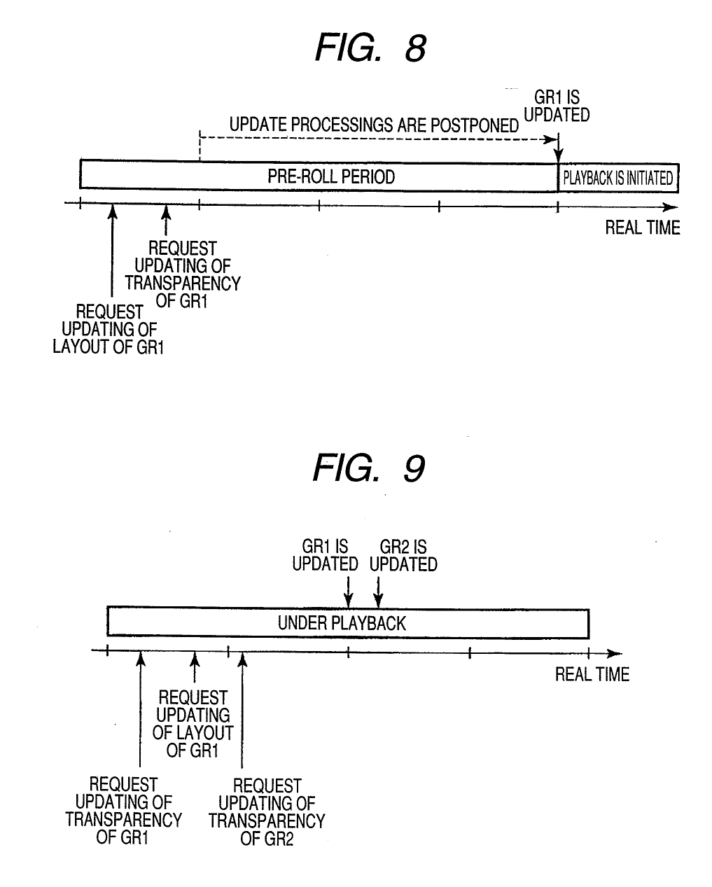

FIG. 6 is a flow chart of an example of transparency and layout update processings to be executed by the playback apparatus according to the embodiment of the invention, in such a manner that the processings are synchronized owing to the synchronization information. FIG. 7 is a flow chart of an example of transparency and layout update processings to be executed by the playback apparatus according to the embodiment of the invention in which a synchronous state and a non-synchronous state exist together. FIG. 8 is a timing chart of an example of transparency and layout update processings to be executed by the playback apparatus according to the embodiment of the invention, in such a manner that the processings are synchronized owing to the setting periods of the transparency and layout updating processings. FIG. 9 is a timing chart of an example of transparency and layout update processings to be executed by the playback apparatus according to the embodiment of the invention, in such a manner that the processings are synchronized owing to the synchronization information.

By the way, the respective steps of flow charts shown in FIGS. 6, 7, 10 and 12 can be replaced with circuit blocks. Therefore, the steps of the respective flow charts can all be re-defined into blocks.

(Technique Using Synchronization Information)

There will be shown below an example of transparency information and change layout information.

The transparency information is composed of transparency, a synchronous mode and group information.

The term “transparency” shows the degree of transparency, the “synchronous mode” shows whether a mode is synchronous or non-synchronous, and the “group information” shows defines the groups to be synchronized such as a group 1 and a group 2.

The change layout information is composed of X coordinates, Y coordinates, a scaling value (n/d), stub X coordinates, stub Y coordinates, a stub width, a stub height, a movement continuing time, a synchronous mode, and group information.

The term “X coordinates” expresses X coordinates after change of the layout; “Y coordinates” expresses Y coordinates after change of the layout; “scaling value” expresses magnifying or scaling-down power; “stub X coordinates” expresses the X coordinates where a stub is started; “stub Y coordinates” expresses the Y coordinates where a stub is started; “stub width” expresses the width of a stub; “stub height” expresses the height of a stub; “movement continuing time” expresses the number of frames necessary to change the layout (that is, expresses the number of frames necessary to be moved); “synchronous mode” expresses a synchronous mode or an asynchronous mode; and, “group information” defines groups to be synchronized such as a group 1 and a group 2.

In the present embodiment, suppose a contents producer has described a script such that, when initiating the output of the video, the playback of a sub video can be initiated in a non-transparent state at an upper left position on the screen. There is executed a playback initiation request (a pre-roll) from a user. Here, the term “pre-roll” means a preparation period for initiation of video playback. At the time when a stream is supplied and all decoders are ready to output a video and a sound, the pre-roll is ended and the playback is initiated. The period of the pre-roll varies depending on the supply speed of a stream, the capabilities of decoders and the like; and, therefore, even in the same stream, the period of the pre-roll differs in each individual payer.

Next, describing an update processing using synchronization information with reference to a flow chart shown in FIG. 6, suppose a contents producer has described a script such that, when initiating the output of the video, the playback of a sub video can be initiated in a non-transparent state at an upper left position on the screen. In the present embodiment, in the script description, the contents producer, when changing the layout, not only describes the layout change information but also describes whether the change of the layout must be synchronized with the setting of the transparency or not, and describes information for identifying the transparency setting to be synchronized (a group ID and the like). In the transparency setting time as well, the contents producer not only describes the transparency information but also describes whether the setting of the transparency must be synchronized with the setting of the layout or not, and describes information for identifying the layout setting to be synchronized (a group ID and the like).

The advanced application presentation engine 12 of the playback apparatus 10 firstly sets the initial layout and transparency with respect to a sub video (Step S21). The initial layout of the sub video is displayed on the screen at an upper right position in the same size as it really is. The state of the initial setting of the transparency is the state of the transparency.

Next, the advanced application presentation engine 12, according to a playback initiate request (pre-roll) from a user, carries out a preparatory processing for initiation of playback (Step S22). The advanced application presentation engine 12, during the pre-roll, carries out the setting of the change of the layout to an upper left position according to the [necessity for synchronization, group 1] existing in the script (Step S23). The layout change during the pre-roll is postponed until the video is output.

Since the script describes the [necessity for synchronization] and [group 1], the player can understand that there exists the setting of the layout to be synchronized. According to the script, there is executed the setting of non-transparency (Step S24). In the script, there are described [necessity for synchronization] and [group 1].

And, the advanced application presentation engine 12 awaits the end of the pre-roll (Step S25). Since the updating of the layout is postponed until the playback is initiated, the updating of the setting of the transparency is also postponed. When the playback is initiated, in order to be able to update the non-transparency setting at the timing of the group 1, the advanced application presentation engine 12 generates a signal for updating the transparency and supplies the same signal to the alpha control portion 20 to thereby update the transparency (Step S26). Further, in order to be able to change the layout at the timing of the group 1 in synchronization with the above-mentioned non-transparency setting, the advanced application presentation engine 12 generates a layout update signal and supplies it to the video renderer 21 to thereby update the layout (Step S27).

In this manner, for the update processings to be synchronized, the contents producer adds, to the script, information as to whether the processing must be synchronized or not, and information for identifying the synchronization information (such as the group 1), whereby, as shown in FIGS. 3 and 5, it is possible to carry out the playback that the contents producer intends.

Also, the operation timing of the thus synchronized update processings is shown in a timing chart of FIG. 8. And, when there are present two or more pieces of information (group 1, group 2 and so on) for identifying the synchronization information, the operation timing thereof is shown in a timing chart of FIG. 9.

Next, description will be given below of a case in which an asynchronous processing is added to the above-mentioned synchronized update processing, with reference to a flow chart shown in FIG. 7.

The advanced application presentation engine 12, based on the script describing the [necessity for synchronization] and [group 1], detects a request for the transparency of the stream (Step S41). Similarly, the advanced application presentation engine 12, based on the script describing the [necessity for synchronization] and [group 1], detects a request for the change of the layout (Step S42). Further, the advanced application presentation engine 12 detects a request for non-transparency not to be synchronized from the script (Step S43).

Next, the update signal generating portion 12-1 of the advanced application presentation engine 12 generates update signals respectively for the layout and transparency at the timing of the group 1 and supplies them to the alpha control portion 20 and video renderer 21 to thereby update the layout and transparency (Step S44). After then, the advanced application presentation engine 12, in order to be able to update the non-transparency setting not to be synchronized, generates an update signal and supplies it to the video renderer 21 to thereby update the transparency (Step S45). Since the update timings of the steps S44 and S45 are asynchronous, they can be reversed each other. However, since there are carried out necessary synchronized update processings, there is no possibility that such display as shown in FIG. 4 against the intension of the contents producer can occur.

As has been described heretofore, since the change of the transparency and the change of the layout are carried out using the synchronization information including the information “[necessity for synchronization], [group 1 and the like]” described in the script, it is possible to realize the display that the contents producer intends.

(Method for Synchronizing Layout and Transparency Update Processings when Initiating Video Playback)

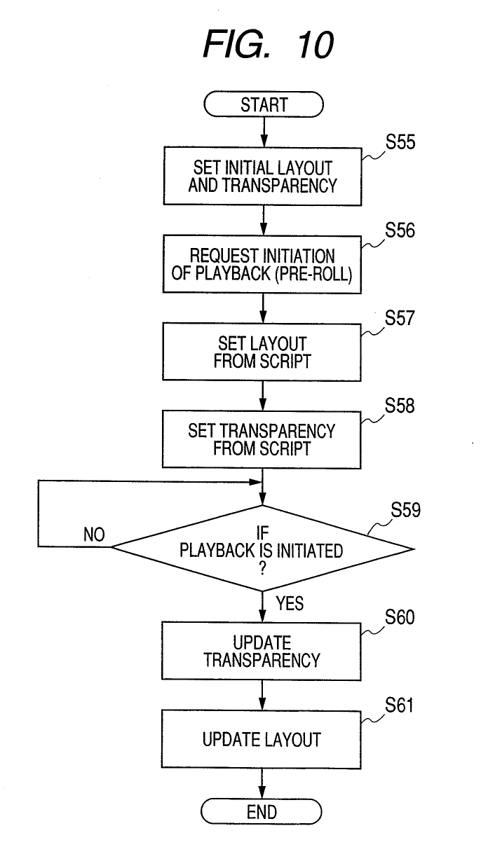

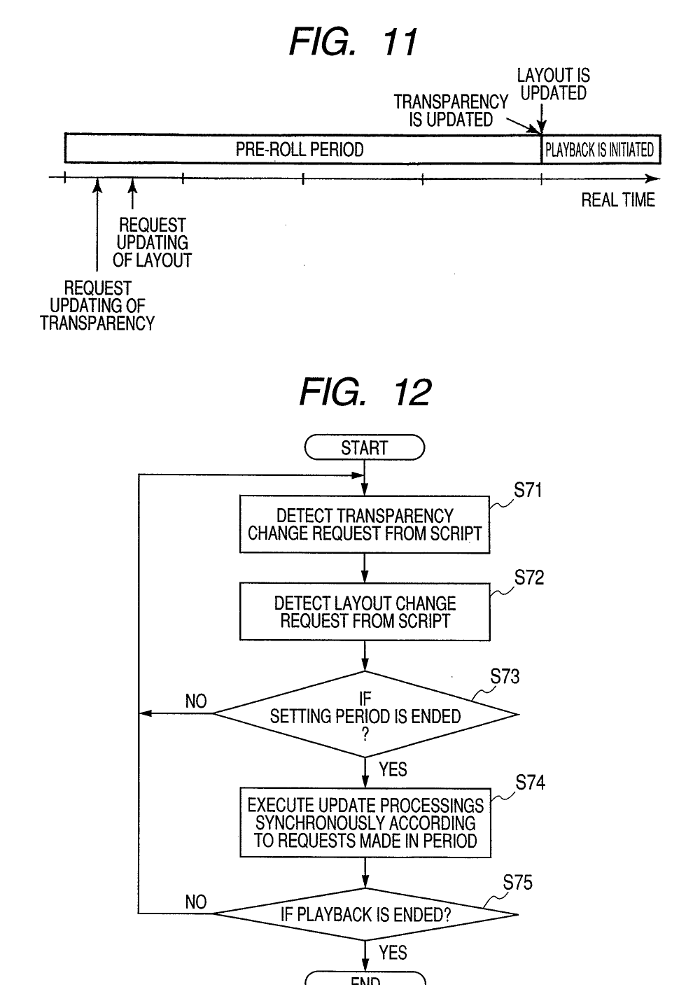

Next, description will be given below of an embodiment in which the layout and transparency update processings are synchronized using the method for synchronizing the layout and transparency update processings in the initiation of the video playback, with reference to the following drawings. FIG. 10 is a flow chart of an example of transparency and layout update processings to be executed by the playback apparatus after the initiation of the video playback. FIG. 11 is a timing chart of the example of the transparency and layout update processings to be executed by the playback apparatus after the initiation of the video playback.

That is, the advanced application presentation engine 12, in the transparency and layout update processings during the pre-roll period, postpones these processings until the video is output. In the present embodiment as well, it is assumed that the contents producer has described a script so as to be able to initiate the playback of the sub video in a non-transparent state at an upper left position on the screen.

The advanced application presentation engine 12, on receiving a stream, sets an initial layout and an initial transparency with respect to a sub video (Step S55). The initial layout of the sub video is displayed at an upper right position on the screen in the same size as it really is. The state of the initial transparency is set as a transparent state.

Next, the advanced application presentation engine 12 receives a playback initiate request (pre-roll) from a user (Step S56). The advanced application presentation engine 12, during the pre-roll, receives a layout change request from the script contained in the stream that the sub video layout is to be changed to an upper left position on the screen (Step S57). The advanced application presentation engine 12 receives a transparency change request (Step S58).

Here, the advanced application presentation engine 12 does not carry out the transparency and layout update processing immediately but postpones the update processing during the pre-roll until the sub video is output (Step S59).

Next, when the playback is initiated, the advanced application presentation engine 12, in order to be able to update the non-transparency setting, generates a transparency update signal and supplies it to the alpha control portion 20 to thereby update the transparency (Step S60). Similarly, the advanced application presentation engine 12, simultaneously with the initiation of the playback, in order to be able to update the layout change to an upper left position on the screen, generates a layout update signal and supplies it to the video renderer 21, whereby the layout and transparency are updated (Step S61). FIG. 11 shows the timing of this update processing.

As described above, in the present embodiment, after the pre-roll, at the time of initiation or after initiation of the playback of the stream, the transparency and layout are changed, thereby being able to synchronize the transparency and layout update processings.

(Method for Synchronizing Transparency and Layout update Processings While Classifying Update Requests in Every Given Period)

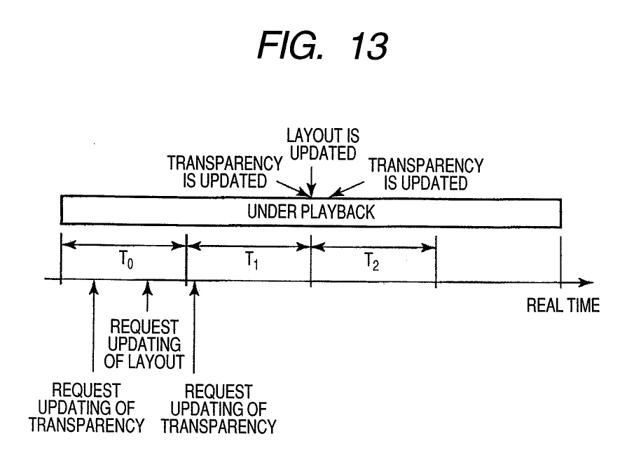

Next, description will be given below of a method for synchronizing the transparency and layout update processings by classifying update requests in every given period. FIG. 12 is a flow chart of an example of transparent and layout update processings to be executed by the playback apparatus in such a manner that the processings are synchronized according to setting periods. FIG. 13 is a timing chart of an example of transparency and layout update processings to be executed by the playback apparatus according to two or more pieces of synchronization information.

That is, the advanced application presentation engine 12, without using the above-mentioned synchronization information of the script, classifies the update requests in each of the real-time setting periods T0, T1, T2, - - - shown in the timing chart of FIG. 13 and carries out the transparency and layout update processings synchronously in each setting period.

Specifically, in the flow chart shown in FIG. 12, the advanced application presentation engine 12 detects a request for change of the transparency from the script (Step S71). Similarly, the advanced application presentation engine 12 detects a request for change of the layout from the script (Step S72). Here, when the setting periods (T0, T1, T2, - - - ) are ended (Step S73), for the change requests in these periods, in order to be able to carry out the transparency and layout update processings synchronously, the advanced application presentation engine 12 generates layout and transparency update signals and supplies them to the alpha control portion 20 and video renderer 21 (Step S74). The advanced application presentation engine 12 carries out these synchronized update processings in each of these setting periods (T0, T1, T2, - - - ) continuously until the playback processing is ended (Step S75).

Using this method as well, without using the synchronization information, the transparency and layout update processings can be executed in a synchronized manner. This makes it possible to playback the advanced contents as the contents producer intends.

<Format>

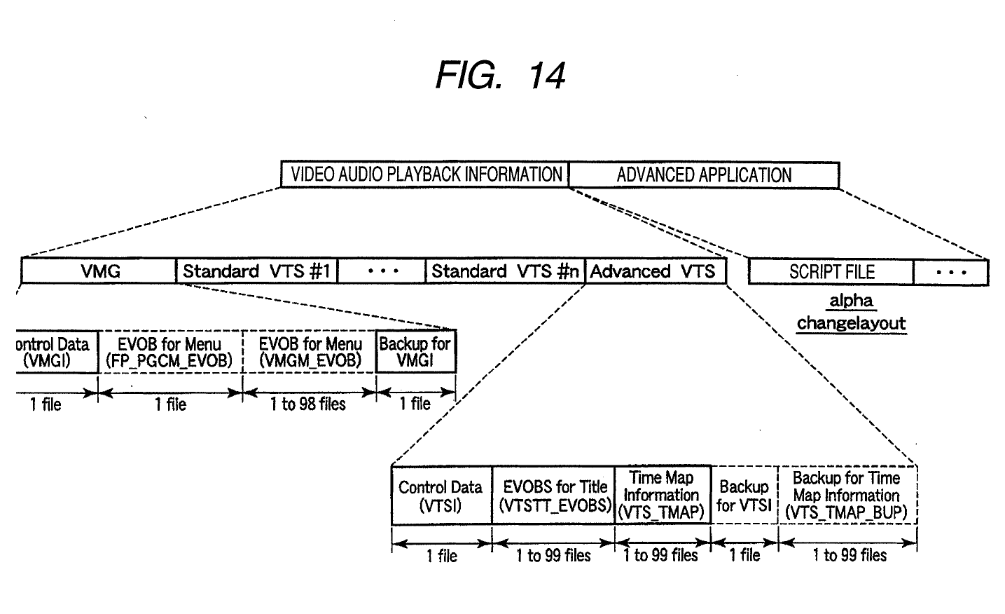

Next, description will be given below of an example of a format containing the above-mentioned transparency information and layout information respectively described in the stream. FIG. 14 is an explanatory view of an example of an optical disk containing transparency setting information and layout setting information provided with the synchronization information.

That is, a format according to the HD DVD-Video standard stored in an optical disk or the like, or a format formed in the shape of a stream, as shown in FIG. 14, includes video audio playback information and advanced application.

Here, the video audio playback information includes control information, that is, VTSI (Video Tilt Set Information), EVOBS, TIME MAP INFORMATION, Backup for VTSI, and Backup for TIME MAP INFORMATION.

On the other hand, the advanced application includes a script file; and, the script file includes information expressing the degree of the transparency, information expressing whether the synchronization of the processings is possible or not, and transparency information described in the script containing identification information on the group 1 and the like. The script file further includes information expressing the coordinates of the destination of the layout, mode information whether the synchronization of the processings is possible or not, and layout information described in the script containing identification information on the group 1 and the like.

By the way, the above-mentioned transparency information described in the script and layout information described in the script are just an example and thus are not limitative, but any other kind of information can also be expected to offer the equivalent operation effect, provided that it includes the synchronization information and update information.

According to the above-mentioned various embodiments, a person skilled in the art can realize the invention. Also, it is easy for a person skilled in the art to think of various modifications of these embodiments and even a person, who has no inventive ability, can easily apply these embodiments to other various embodiments. Therefore, the invention covers a wide range without departing from the disclosed principles and new characteristics of the invention and is not limited to the above-mentioned embodiments.

As described with reference to the embodiment, there is provided a playback apparatus, a playback method and a format, which synchronize the timings of the layout update and transparency update processings to thereby eliminate the above-mentioned display condition.

Since the update processing of the layout and the update processing of the transparency are executed synchronously with each other, it is possible to eliminate the occurrence of inconveniences on a screen such as the occurrence of an unexpected display.

What is claimed is:

1. A playback apparatus, comprising:
a decoder configured to decode stream data to output a video signal,
a generator configured to generate a transparency update signal and a layout update signal based on transparency information and layout information, respectively, that are described in a script file such that the transparency update signal and the layout update signal are generated to synchronize with each other; and
an output unit configured to output the video signal with a transparency updated according to the transparency update signal and with a layout coordinate synchronously updated according to the layout update signal.

2. The playback apparatus of claim 1, wherein the script information and the layout information each comprise identification data, and wherein the generator is configured to synchronize the transparency update signal and the layout update signal when the script information and the layout information comprise identical identification data.

3. The playback apparatus of claim 2, wherein the transparency information and the layout coordinate information further comprise synchronization mode data indicating that the transparency update signal and the layout update signal need to be synchronized.

4. The playback apparatus of claim 1, wherein when a transparency update timing indicated by the transparency information and a layout update timing indicated by the layout information are set at a timing before the video signal is played back, the generator is configured to update the transparency and the layout coordinate of the video signal upon or after starting playback the video signal.

5. The playback apparatus of claim 1, wherein the generator is configured to detect a transparency update timing indicated in the transparency information and a layout update timing indicated in the layout information at intervals of a predetermined period, and wherein the generator is configured to synchronize the transparency update signal and the layout update signal when the transparency update timing and the layout update timing is within the predetermined period.

6. The playback apparatus of claim 1, wherein the video signal comprises sub-video data; and wherein the output unit is configured to update the transparency and the layout coordinate with respect to the sub-video data.

7. The playback apparatus of claim 1, wherein the transparency information comprises transparency setting information defined by the HD DVD-Video standard, and wherein the layout information comprises layout change information defined by the HD DVD-Video standard.

8. A method for controlling a playback apparatus, comprising:
decoding stream data;
outputting a video signal included in the decoded stream data;
generating a transparency update signal and a layout update signal based on transparency information and layout information, respectively, that are described in a script file such that the transparency update signal and the layout update signal are generated to synchronize with each other; and
outputting the video signal with a transparency updated according to the transparency update signal and with a layout coordinate synchronously updated according to the layout update signal.

9. The method of claim 8 for controlling the playback apparatus, wherein the script information and the layout information each comprise identification data; and wherein the generating step is performed when the transparency information and the layout information comprise identical identification data.

10. A method of using video format information to smooth transparency transitions, the method comprising:
providing video format information described in a script, the video format comprising:
transparency information comprising:
a transparency value;
mode information indicating whether synchronization is acceptable; and
identification data of synchronization, and
a layout information comprising:
layout coordinate information;
mode information indicating whether synchronization is acceptable; and
identification data of synchronization,
decoding stream data;
outputting a video signal included in the decoded stream data;
generating a transparency update signal and a layout update signal based on the transparency information and the layout information, respectively, such that the transparency update signal and the layout update signal are generated to synchronize with each other; and
outputting the video signal with a transparency updated according to the transparency update signal and with a layout coordinate synchronously updated according to the layout update signal.
